(19) United States
(12) Patent Application Publication
(10) Pub. No.: US 2010/0157170 A1
(43) Pub. Date: Jun. 24, 2010

(54) SYSTEM AND METHOD FOR OPERATION OF A TELEVISION WITH A REMOTE CONTROL

(75) Inventors: Eric Stephen Carlsgaard, Zionsville, IN (US); Mark Gilmore Mears, Zionsville, IN (US); James Duane Tenbarge, Fishers, IN (US)

Correspondence Address: FLETCHER YODER P.C., 7915 FM 1960 RD. WEST, SUITE 330, HOUSTON, TX, 77070, US

(73) Assignee: Shenzhen TCL New Technology LTD, Shenzhen, CN (unknown)

(21) Appl. No.: 12/600,963

(22) PCT Filed: Jul. 17, 2007
(86) PCT No.: PCT/US07/16219

§ 371 Date: Nov. 19, 2009

(30) Foreign Application Priority Data
Jun. 28, 2007 (CN) CN200710076236.3

(51) Int. Cl. H04N 5/44

(52) U.S. Cl. 348/734; 348/E05.096

(57) ABSTRACT

There is provided a system and method for a television remote control system. More specifically, in one embodiment, there is provided a remote control, a control element configured for vertical movement, horizontal movement and axial movement, and a television configured to activate various television features upon receiving a signal from the remote control indicating an activation direction of the control element, wherein the television is configured to activate a volume control feature when the activation direction is a first or second direction and the television is operating in a viewing mode, and wherein the television is configured to activate a television content selection feature when the activation direction is a third or fourth direction and the television is operating in the viewing mode, wherein the first, second, third, and fourth directions are each different.

### FIELD OF THE INVENTION

The present invention relates generally to television interfaces. More particularly, the present invention relates to a television interface system comprising a remote control with a manually actuatable element that may be utilized to initiate various television functions.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Watching television is a very popular pastime in the United States and other countries. Television viewers often utilize remote controls to manage their television viewing experience. For example, remote controls are used to change channels, scan through recorded video, adjust volume, manipulate viewing settings, enable closed captioning, turn the television on and off, and so forth. To accommodate the introduction of additional functionality (e.g., digital television, sub-channels for broadcast television, digital recording, and the like), traditional remote controls may include a large number of buttons for specific procedures (e.g., buttons to step through channels, buttons to control recording features, number keys to directly input channels, and other specific input options). Further, some traditional remote controls include menu navigation buttons that allow a user to navigate through menus in a step-by-step process based on up, down, left and right (UDLR) commands. User interface systems that include buttons for all of the available television operation features often results in a large remote control with a large number of buttons that can complicate use of the remote control and intimidate users.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for remote control of a television. One embodiment comprises a control element configured for vertical movement, horizontal movement and axial movement, and a television configured to activate various television features upon receiving a signal from the remote control indicating an activation direction of the control element, wherein the television is configured to activate a volume control feature when the activation direction is a first or second direction and the television is operating in a viewing mode, and wherein the television is configured to activate a television content selection feature when the activation direction is a third or fourth direction and the television is operating in the viewing mode, wherein the first, second, third, and fourth directions are each different.

### BRIEF DESCRIPTION OF THE DRAWINGS

Advantages of the invention may become apparent upon reading the following detailed description and upon reference to the drawings in which:

FIG. 1 is a block diagram of a television system in accordance with an exemplary embodiment of the present invention;

FIG. 2 is a plan view of a remote control in accordance with an exemplary embodiment of the present invention;

FIGS. 3 and 4 are representations of a screen display including a graphical menu or main menu in accordance with an exemplary embodiment of the present invention;

FIG. 5 is a representation of the screen display including a number selection menu in accordance with an exemplary embodiment of the present invention;

FIG. 6 is a representation of the screen display including a content selection menu associated with a television content selection feature of the system in accordance with an exemplary embodiment of the present invention;

FIG. 7 is a representation of the screen display including an audio volume control menu associated with a volume control feature of a system in accordance with an exemplary embodiment of the present invention; and

FIG. 8 is a block diagram of a process in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

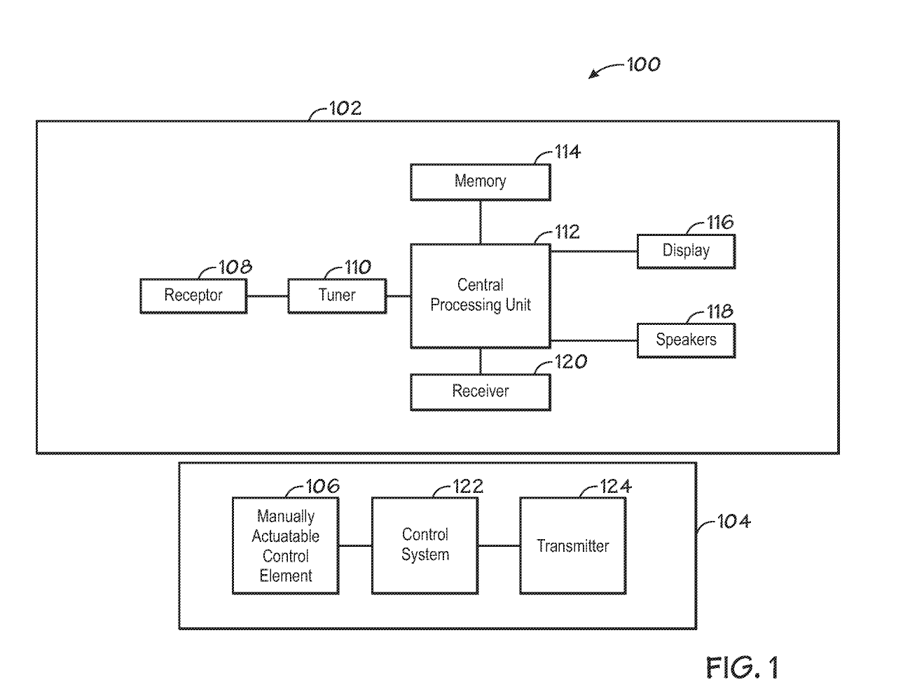

FIG. 1 is a block diagram of a television system in accordance with an exemplary embodiment of the present invention. The television system is generally indicated by reference numeral 100. The television system 100 includes a television 102 and a remote control 104 that cooperate to facilitate operation of the television 102 by a user. Specifically, in accordance with exemplary embodiments, the remote control 104 includes a manually actuatable control element 106 that facilitates user selection of a number of different television commands. For example, a user may provide a command (e.g., a command to increase volume or tune another channel) to the television 102 by physically manipulating the control element 106 of the remote control 104 in a manner that corresponds to the desired command. This may include utilizing the control element 106 to navigate a menu of available command selections, scroll through channels, increase/decrease audio volume, and so forth at variable speeds depending on a manner in which the control element is activated. In other words, present embodiments may control operational features of the television 102 based on certain activation characteristics observed via the control element 106.

The remote control 104 translates physical manipulation of the control element 106 into a command (e.g., data presented via electrical signals, radio signals, or light signals) and communicates the command to the television 102. The television 102 receives the command and performs a function (e.g., increase the volume or change the channel) based on the command. The function may be selected from a table stored in the television 102 that correlates various commands with various functions. In other words, the television 102 may translate the command received from the remote control 104 into a function using a correlation table. In the illustrated embodiment, the command is communicated wirelessly from the remote control 104 to the television 102. However, in some embodiments, the command may be communicated via a wire or cable.

The television 102 includes a receptor 108 (e.g., a cable inlet or antenna), a tuner 110, a central processing unit or processor 112, a memory 114, a display 116, speakers 118, and a receiver 120. The receptor 108 may be adapted to receive signals (e.g., audio and video signals) from a provider, such as a terrestrial broadcaster or a cable head-end. The tuner 110 may be adapted to facilitate selection of certain provider signals for presentation on the display 116 and over the speakers 118. The memory 114 may be adapted to hold machine-readable computer code that causes the processor 112 to perform an exemplary method based on signals received from the remote control 104. The receiver 120 may be adapted to facilitate communication between the television 102 and the remote control 104. For example, in the illustrated embodiment, the receiver 120 is adapted to receive wireless signals or commands from the remote control 104 and communicate the commands to the processor 112.

The remote control 104 includes the manually actuatable control element 106, a control system 122, and a signal transmitter 124. The control element 106 may be adapted to facilitate selection of a number of different commands via simplified user interaction with the control element 106. For example, rather than a traditional button array, the control element 106 may include a joystick, a scroll wheel, or a tilt disk that enables a user to make direct commands, navigate through a menu, scroll through menu items, and make selections in the menu. In some embodiments, the control element 106 may cooperate with other control features (e.g., buttons) to facilitate a user's control of the television. The control system 122 may receive one or more signals from the control element 106 and produce one of a plurality of television commands in response to the one or more signals. For example, the one or more signals may indicate an activation characteristic of the control element 106, such as whether the control element was pushed up, down, left, right, or axially depressed. The transmitter 124 communicates the commands to the television 102 as electrical signals, radio signals, light signals, or the like.

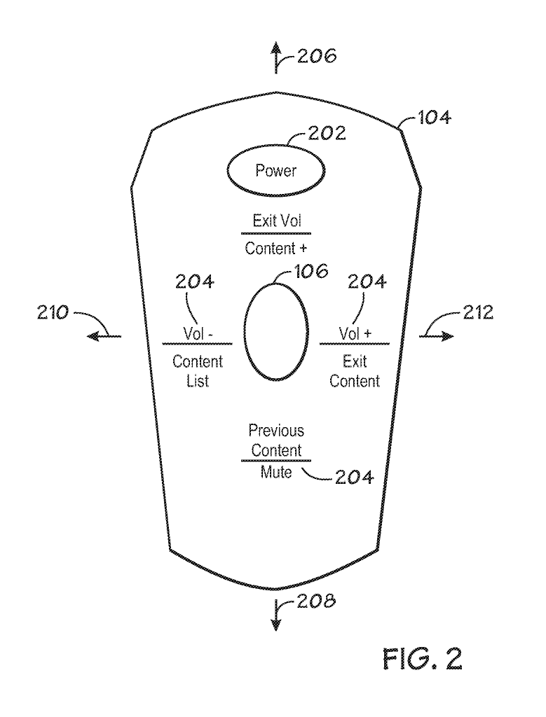

FIG. 2 is a plan view of the remote control 104 in accordance with an exemplary embodiment of the present invention. The remote control 104 includes a body 200, the control element 106, a power button 202, and text indicators 204. As set forth above, the control element 106 may include one of various control element types. For example, the control element may include a joystick, a scroll wheel or a tilt disk. The power button 202 is representative of various different types of additional input features that may supplement operation of the control element 106. For example, the control element 106 may include a scroll wheel that can be activated by tilting it to the left or right to activate certain features, or the tilt functions may be replaced by separate buttons on the left and right of the scroll wheel. The text indicators 204 may provide a user with information relating to what commands are related to manners of activating the control element 106. For example, the text indicators 204 around the control element 106 may indicate that pressing the control element 106 in the direction of the text will initiate a command described by the text indicators 204. In some embodiments, multiple text indicators 204 may be associated with a single direction because different commands may be initiated depending on a characteristic of activation or a mode in which the remote control 104 is operating.

In the illustrated embodiment of FIG. 2, the control element 106 is adapted for activation in five directions. A first direction may include an up direction 206, a second direction may include a down direction 208, a third direction may include a left direction 210, a fourth direction may include a right direction 212, and a fifth direction may include an axial direction (into or out of the page). In other words, the control element 106 is configured for vertical movement (e.g., activation in the up direction 206 and the down direction 208), horizontal movement (e.g., activation in the left direction 210 and the right direction 212), and axial movement (e.g., activation in the axial direction). Regarding axial activation, the control element 106 may be activated by pressing it toward the remote control 104 along a vertical axis of the control element 106 (e.g., directly down toward the body 200). For example, if the control element 106 is a joystick, it may be activated by pushing the top of the joystick toward its base in the direction of the joystick's length. Similarly, if the control element 106 is a tilt disk or a scroll wheel, it may be activated by pushing directly down toward the body 200 on a central portion of the tilt disk or scroll wheel. In some embodiments, the control element may include multiple buttons arranged along a base of the control element 106 such that they are activated based on what manner and/or in what direction the control element 106 is activated.

While present embodiments may be compatible with traditional remote controls that utilize separate buttons for navigation or a conventional button array, the television system 100 may be configured to operate with a simplified or substantially minimalized remote control interface. For example, in one embodiment, the remote control 104 merely includes input features for four navigational directions, a select feature, and an on/off feature. In order to reduce the complexity of the remote control 104, the system 100 may be configured to operate based only on commands received from these input features, and input features other than these may be excluded from the remote control 104. It should be noted that some embodiments may include input features that detect multiple levels of speed or position in each direction of activation to accelerate responses and so forth, as will be discussed in further detail below. However, as indicated above, other embodiments are minimalized to exclude even these additional input features. The input features associated with the four navigational directions may be activated by pushing the control element 106 in one of the four directions 206, 208, 210, and 212. The select feature may be initiated via axial activation of the control element 106. Further, the on/off feature may be activated via the power button 202.

Manipulation or activation of the control element 106 may facilitate initiation of television commands, navigation of a menu, or cause changes in a mode of operation based on one or more characteristics of the activation. In one embodiment, if a user presses the control element 106 in a particular direction, a corresponding signal is sent to the control system 122. The control system 122 then translates the signal into a command for communication to the television 102 by the transmitter 124. For example, if the control element 106 is initially pushed in the up direction 206 from a viewing mode, the various features of the remote control 104 may cooperate to provide a command corresponding to various television operations, such as bringing up an on-screen display, tuning a next channel, or increasing/decreasing an audio volume. It should be noted that a viewing mode may include a mode of operation wherein a menu is not being displayed. The television 102 may include a table in the memory 114 that correlates received commands to particular actions to be taken by the television 102.

The system 100 may be configured to provide a graphical user interface with a representation of available television functions on the display 116 based on input from the remote control 104. This user interface may include a menu that is configured to be readily navigable via commands from the remote control 104. Further, the user interface may be optimized for rapid access to commonly utilized or high priority tasks. That is, if a command request from the remote control 104 is common or has a high priority, that command request may be more readily accessible via the user interface than a low priority or less common command request. For example, the placement of command options in a menu may correspond to a priority associated with those options to enable quick access. By designating a high priority command option as the default first selection in a menu, a user can immediately select that command option upon entering the menu, thus saving time and simplifying operation of the system 100.

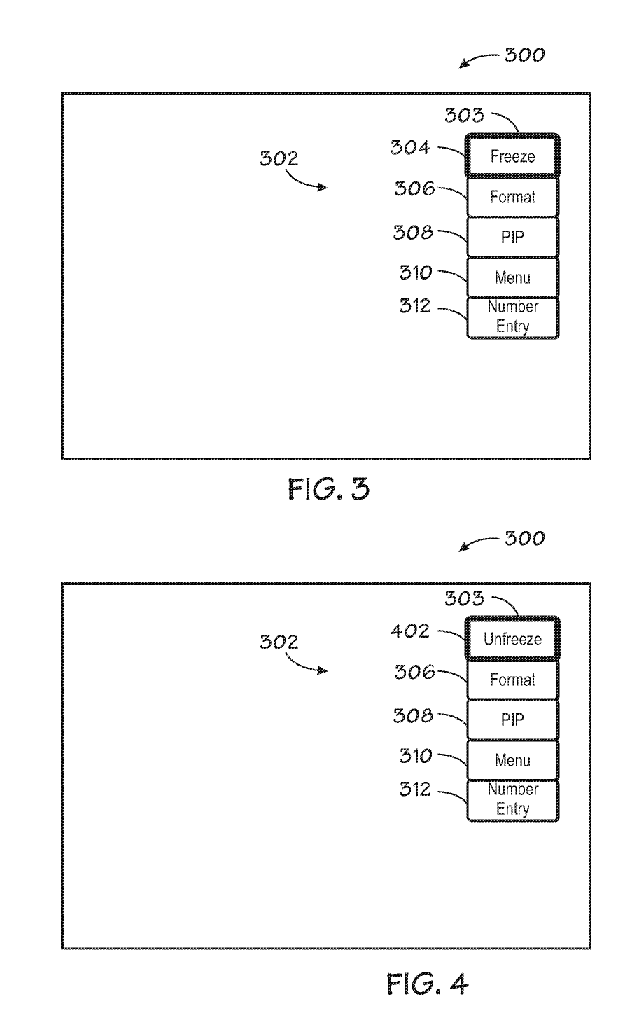

FIG. 3 is a representation of a screen display 300 including a graphical menu 302 (e.g., a main menu) in accordance with an exemplary embodiment of the present invention. The screen display may include video from an on-going television program or the like. In one embodiment, after the system power is turned on (e.g., by activating the power button 202), a select command may be interpreted by the system 100 based on information stored in the memory 114 as a request to activate the menu 302. For example, after the system is powered, if the control element 106 is axially activated prior to initiation of any directional commands, the axial activation of the control element 106 may cause the system 100 to display the menu 302 in the screen display 300. The menu 302 may include multiple options arranged by priority, the first option being the highest priority and the last option being the lowest priority.

The first option may be defined as the default option or the option that is already selected (but not activated) when the menu is opened. The lower the priority of an option, the more manipulation of the control element 106 may be required to select that option. Accordingly, the lowest priority option may be positioned as the last option in the menu 302. For example, a user may have to move a cursor 303 down several times to reach the last option in the menu 302. In the illustrated embodiment, the menu 302 includes various virtual buttons or options that include a freeze command 304, a format command 306, a picture-in-picture (PIP) command 308, a menu command 310, and a number entry command 312. It should be noted that in the illustrated embodiment, the first option is the freeze command 304 and the last option is the number entry command 312. Upon activation of the menu 302, the freeze command 304 would already be selected or highlighted by the cursor 303, as illustrated in FIG. 3. In contrast, four navigational commands in the down direction would have to precede selection of the number entry command 312.

As set forth above, in the embodiment illustrated by FIG. 3, the first option in the menu 302 is the freeze command 304. The freeze command 304 corresponds to a function that quickly stops the normal progression of video (e.g., video for a television show) being displayed on the display 116 and holds (or freezes) the present frame. In other words, the screen display 300 is frozen on the display 116 at the time the freeze command 304 was activated. For televisions that are adapted to utilize the freeze command 304, it may be considered a high priority option since holding a desired frame requires rapid activation. Thus, the freeze command 304 may be positioned as the default or first option in the menu 302, which enables rapid access to that option. In some embodiments, the system 100 does not include features supporting the freeze command 304 and, thus, a different command is given first priority and the default location in the menu 302.

Positioning a particular command as the default or first option facilitates selection of the command via double-activation (e.g., double-clicking) of the control element 106. For example, a user may open the menu 302 via axial activation of the control element 106 and then select the first option, which is already highlighted by the cursor 303, by again axially activating the control element 106 without an intervening activation (e.g., a directional movement of the control element 106). In other words, the positioning of an option as the first selection allows a user to rapidly activate that option by initiating a select feature twice in a row (e.g., a first activation to open the menu and a second activation to select the first option or default option). In the illustrated embodiment, once the video has been frozen by selection of the freeze command 304, the first option in the menu 302 may be changed to an unfreeze command 402, as illustrated in FIG. 4. Thus, a second double-activation of the control element 106 from a viewing state of the system 100 may deactivate the freeze command 304. Similar menu changes may be utilized with various menu options in accordance with present embodiments.

Activating different commands after an initial activation of the select feature may facilitate navigation through available options provided in the menu 302. For example, in one embodiment, an initial axial activation of the control element 106 opens the menu 302 and a subsequent directional command initiated by moving the control element 106 in one of the four directions 206, 208, 210, and 212 may cause different options to be highlighted or selected (e.g., enclosed by the cursor 303). Once an option is highlighted or selected, it can be activated by activation of the select feature (e.g., axial activation of the control element 106). Some options may expand to provide additional options upon selection. Other options may initiate a command signal to the system 100.

As set forth above, in the embodiments illustrated by FIGS. 3 and 4, the options provided by the menu 302 are arranged according to priority from top to bottom. In other embodiments, different priorities and arrangements may be utilized but the highest priority option is initially highlighted or selected. As discussed above, the first priority is given to the freeze command 304. The format command 306 is deemed to be the second most important option available from the initial menu 302 because it is frequently employed by users. Initiation of the format command 306 may enable zooming to adjust video formats on the screen display 300 and so forth. In some embodiments, the format command 306 may be given the highest priority and the default position in the menu 302 because the system 100 does not include features relating to the freeze command 304. The PIP command 308 is given the third highest priority because users frequently opt to watch multiple programs utilizing PIP functionality. The menu command 310 is given the fourth highest priority to facilitate activation of additional menus and to set-up or adjust television settings. Finally, in the illustrated embodiment, the number entry command 312 is provided the lowest position in the menu 302. The number entry command 312 facilitates direct entry of a particular channel or desired input.

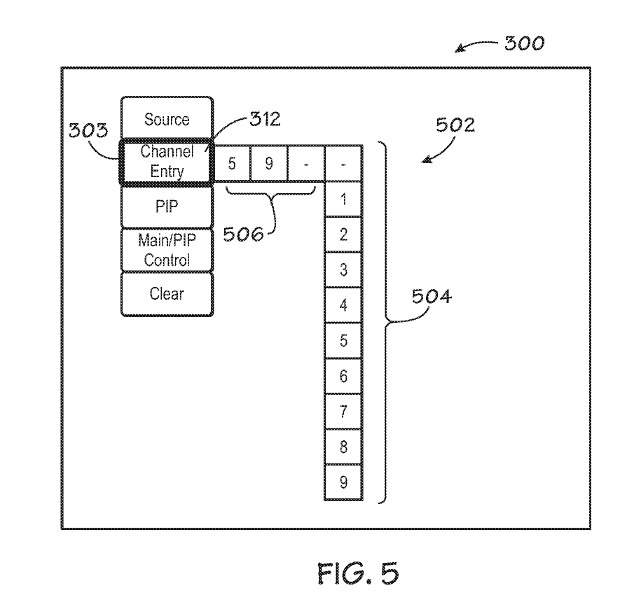

FIG. 5 is a representation of the screen display 300 including a number selection menu 502 in accordance with an exemplary embodiment of the present invention. The number entry command 312 may be initiated to open the number selection menu 502 and may be utilized instead of a number keypad or button array to directly input a channel number. In the illustrated embodiment of FIG. 5, the number entry command 312 has been activated to expand out number options 504. The control element 106 may be manipulated to navigate the number options 504 and select the desired numbers. Once the numbers have been selected, they may be displayed in number entry box 506. Once the number entry box 506 is filled out, the television 102 may tune in the associated channel. In the illustrated embodiment, the user has already selected numerals 5 and 9 from the number options 504. The number entry command 312 facilitates minimalization of the remote control by replacing the traditional button array and/or number keypad that would be utilized to directly enter channel numbers.

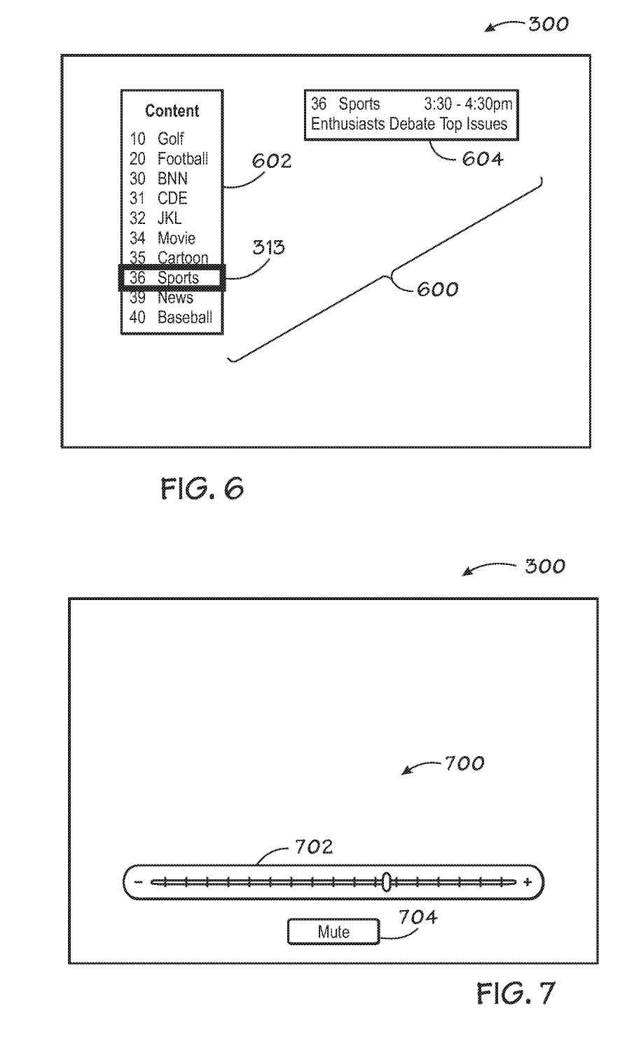

FIG. 6 is a representation of the screen display 300 including a content selection menu 600 associated with a television content selection feature of the system 100 in accordance with an exemplary embodiment of the present invention. In accordance with present embodiments, the system 100 may perform a full channel/input set-up process during an initial boot of the system 100 or upon initiation by a user. This full channel/input set-up process may include analog/digital and antenna/cable channel scanning, input label selection options (e.g., DVD or VCR), and detection of other networked content (e.g., a networked personal computer with music and digital photos). This set-up process may be controlled or initiated via menu commands that are accessible and navigable using the remote control 104. The information associated with this set-up process may be stored in the memory 114, which may include a Flash memory or semi-permanent memory that will be accessible to the content selection feature.

The content selection feature may be accessed or activated with a directional movement of the control element 106. For example, in one embodiment, pressing the control element 106 in the up direction 206 from a viewing status of the system 100 may open the content selection menu 600. That is, during normal viewing of a television program or the like, a user may press the control element 106 in the up direction to display the content selection menu 600 in the screen display 300. The content selection menu 600 includes a channel list 602 and an information window 604. The channel list 602 includes channel selections or options obtained via the channel scanning process discussed above. The information window 604 displays information about a channel that is highlighted and/or activated. For example, upon selection of a channel with the cursor 303, the information window 604 may display data (e.g., a description of program content, call letters, and updates) obtained during the scanning process and/or data received in periodic updates to the information associated with each channel selection, as illustrated in FIG. 6.

Once the content selection menu 600 is open, the channel list 602 may be navigated by moving the control element 106 in the up direction 206 and the down direction 208. For example, pressing the control element 106 in the up direction 206 may cause an option in the channel list 602 above a currently highlighted option to be highlighted and subsequent movement of the control feature in the down direction 210 will highlight the original option again. Similarly, movements in the opposite directions will have opposite results. Further, different directions may be utilized depending on arrangement of the content selection menu 600. Once a channel selection in the channel list 602 is highlighted, it may be activated by employing the select feature. For example, a user may navigate the selection menu 600 to highlight a particular channel selection of interest and then activate that channel via axial activation of the control element 106. Upon activation of the channel selection, the system 100 may tune the channel associated with the channel selection based on information stored in the memory 114.

When the content selection menu 600 is active, as illustrated in FIG. 6, movement of the control element 106 in a particular direction may initiate certain specified commands. For example, pressing the control element 106 in the right direction 212 may initiate a command from the remote control 104 that causes the system 100 to close all on-screen displays (e.g., close the content selection menu 600). Activation and deactivation of the selection menu 600 may define a threshold in which different commands are associated with movements of the control element 106 than those commands associated with movements of the control element 106 in other modes of operation (e.g., a viewing mode). In some embodiments, the threshold may be defined by a time limit or the time limit in combination with activation and deactivation commands. For example, the content selection menu 600 may automatically close and return to a standard viewing mode when a certain amount of time has passed since activation of the content selection menu 600.

It should be noted that a theme may be associated with the content selection menu 600 that corresponds to indicators on the remote control 104. For example, the graphics used in the content selection menu 600 may include a substantial amount of a particular color that corresponds to the color of text associated with certain commands initiated by the remote control 104. Specifically, for example, portions of the text 204 positioned to the right of the control element 106 may be blue and may indicate that pressing the control feature in that direction will cause the system 100 to exit the content selection menu 600, which may include a substantial amount of blue in related graphics.

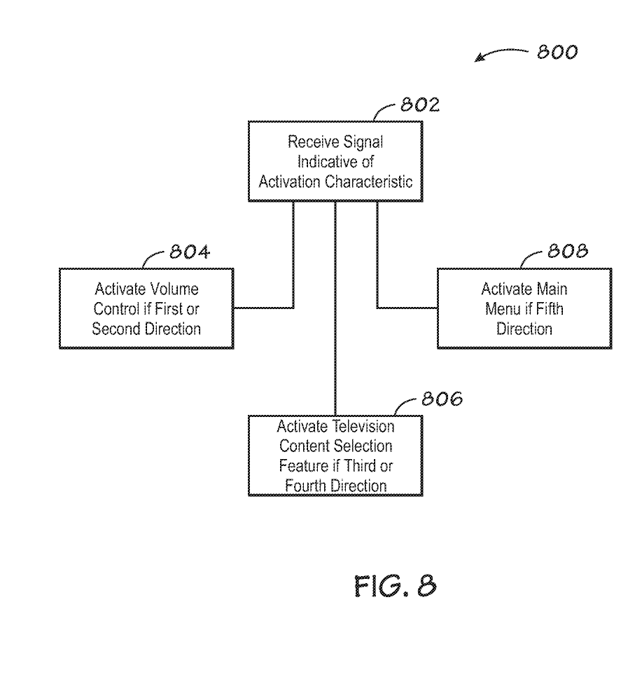

FIG. 7 is a representation of the screen display 300 including an audio volume control menu 700 associated with a volume control feature of the system 100 in accordance with an exemplary embodiment of the present invention. The audio volume control menu 700 may include a progress bar 702 that indicates audio volume levels and a mute signal 704 that is visible when a mute function is active.

When the system 100 is operating in a viewing mode (e.g., a television program is being displayed) and a menu is not active, initial movement of the control element 106 in the left direction 210 or the right direction 212 may initiate the audio volume control feature (e.g., open the audio volume control menu 700) and begin changing the audio volume based on the direction of movement. For example, pressing the control element 106 in the right direction 212 may cause the audio volume to increase and pressing the control feature in the left direction 210 may cause the audio volume to decrease. Pressing the control element 106 in either the left or right directions 210 and 212 may open the audio volume control menu 700. After the audio volume control menu 700 is initiated, movement of the control element 106 in the down direction 208 may initiate the mute function causing the system to completely or almost completely eliminate audio until the mute function is deactivated. Movement of the control element 106 in the up direction 206 after the audio volume control menu 700 is open may close the audio volume control menu 700. In other embodiments the directions associated with the functions discussed above with respect to audio may be interchangeable.

Activation and deactivation of the audio volume control menu 700 may define a threshold in which different commands are associated with movements of the control element 106 than those commands associated with movements of the control element 106 in other modes of operation (e.g., a viewing mode). In some embodiments, the threshold may be defined by a time limit or the time limit in combination with activation and deactivation commands. For example, the audio volume control menu 700 may automatically close and return to a standard viewing mode when a certain amount of time has passed since activation of the audio volume control menu 700.

It should be noted that, like the content selection menu 600, a theme may also be associated with the audio volume control menu 700 that corresponds to indicators on the remote control 104. For example, the graphics used in the audio volume control menu 700 may include a substantial amount of a particular color that corresponds to the color of text associated with certain commands initiated by the remote control 104. Specifically, for example, portions of the text 204 positioned to the right of the control element 106 may be gold and may indicate that pressing the control feature in that direction will cause the system 100 to increase the audio volume when in the audio volume control menu 700, which may include a substantial amount of gold in related graphics.

As mentioned above, additional activation or input features may be included in some embodiments of the present invention without requiring substantial complication of the remote control 104. For example, activating the control element 106 in a particular manner may cause the remote control to initiate specific television commands. If the activation of the control element 106 has certain characteristics, different commands may be initiated or the commands may be modified. For example, if the control element 106 is activated in a predefined direction within a time threshold of making a channel selection, the television 102 may be signaled to tune the previously displayed channel. In another example, if the control element 106 is activated for a certain amount of time in a particular direction or to a certain degree in a particular direction, the command associated with activation in that direction may be modified to perform differently (e.g., more rapidly).

The signal produced by the control element 106 as a result of being activated may be generated at one of a plurality of different levels based on a characteristic of the activation. Further, the commands produced by the remote control 104 may correspond to the level of the signal, thus changing the operation of the television 102 based on the signal level. Several different activation characteristics may be utilized to change the level of the signal. For example, among other characteristics, a length of time that the control element 106 is activated, a number of times the control element 106 is activated consecutively in a certain period of time, or a respective distance traveled by a portion of the control element 106 during activation are activation characteristics that may impact signal levels. Certain activation characteristics may depend on whether the control element 106 is of a certain type. For example, different activation characteristics may be associated with a joystick, a tilt disk, a scroll wheel, or other control element types.

In accordance with an exemplary embodiment, if the control element 106 includes a joystick, an activation characteristic may include the extent to which the joystick is pressed in a certain direction. For example, if the joystick is pressed partially in the up direction 206, it may produce a signal at a first level. Based on this signal level, the control system 122 may generate a command to cycle through channels on the television 102 at a first pace. If the joystick is pressed fully in the up direction 206, it may produce a signal at a second level, and the control system 122 may modify the command to cycle through the channels at a second pace that is more rapid than the first. In some embodiments, multiple different signal levels may be produced depending on the extent to which the joystick is pressed in a direction. In other embodiments, activation characteristics other than a distance the joystick is pushed may be similarly utilized. Indeed, various activation characteristics may have multiple signal levels associated with degrees of activation and these signal levels may correlate to any number of television functions (e.g., channel changing, menu navigation, or volume adjustment).

Multiple different activation characteristics may be considered in determining a signal level. For example, the length of time that activation lasts and/or the number of times activation occurs within a fixed period may be defined as activation characteristics. Further, various activation characteristics may be considered separately or in combination to provide a signal level. For example, referring to the exemplary joystick discussed above, holding the joystick pressed fully in the up direction for a defined period of time may modify the command associated with simply pressing the joystick fully in the up direction 206 such that the channels are cycled through at a third pace that is more rapid than the second pace. Similar correlations between activation characteristics and commands may be applied to various different functions of the television 102. For example, scrolling through menu selections, increasing or decreasing audio volume, setting a clock, and so forth are all commands that may have an increased or decreased pace that is controlled by certain activation characteristics associated with the control element 106.

The joystick described above is merely one example of a correlation between activation of the control element 106 and a television command produced by the remote control 104 in accordance with present embodiments. As set forth above, various different activation characteristics may be associated with different commands. Further, different types of control elements may enable different activation characteristics to be associated with television commands. For example, a user may increase or decrease the speed of scrolling through menu options, cycling through channels or increasing/decreasing audio volume by rolling a scroll wheel more rapidly or more slowly in a desired direction. Similarly, a user may initiate such commands by pressing a tilt disk in a particular direction for a period of time that exceeds one or more thresholds.

In one embodiment, various lengths of time that the control element 106 is activated (e.g., depressed in a particular direction) may cause different signal levels to be produced and, thus, different commands to be issued from the remote control 104. For example, the control element 106 may include a tilt disk that can be depressed in multiple directions to produce different commands. In one embodiment, pressing the tilt disk in a particular direction to provide a continuous command for less than 400 ms may produce a first level signal. The first level signal may correspond to a single command with a first rate (e.g., scroll at a rate of one selection per 20 ms). The level of the signal may be incrementally increased as the continuous command is provided for longer lengths of time. For example, after 2000 ms a second signal level may be reached, after 3000 ms a third signal level may be reached, and so forth. Each signal level may correspond to how rapidly a particular feature is changed. For example, the higher the signal level when scrolling through a menu, the less time each menu option will be displayed before scrolling to the next menu option. If the continuous command stops, the last selection may be displayed for a period of time and then enabled. For example, if a user is scrolling through channels by pressing and holding the tilt disk in the up direction 206 and releases the tilt disk upon reaching a desired channel, the television 102 may display the channel number for 500 ms before actually tuning the selected channel.

As set forth above, certain features of present embodiments may enable a user to scroll through channels on the television 102 at a rapid pace. During the process of scrolling through the channels, embodiments of the present invention may prevent or avoid delays associated with the television 102 attempting to tune each channel that is selected during scrolling. For example, if a user wants to change the channel on a television from channel 2 to channel 26, present embodiments may enable rapid scrolling from channel 2 to channel 26 by preventing intermediate channels from being tuned. Intermediate channels may be defined as channels that are passed over without a delay of a certain amount of time. Specifically, the television 102 may be commanded to avoid tuning a channel until a destination channel is reached, as indicated by resting on selection of the destination channel (e.g., channel 26) for a certain length of time. This may avoid unnecessary time spent on tuning channels that the user has no interest in viewing and simply wishes to pass over while scanning to a desired channel. The prevention of intermediate tuning may be a feature that is initiated in the television 102 based on the level of the signal received from the control element 106.

FIG. 8 is a block diagram of a process in accordance with an exemplary embodiment of the present invention. The process is generally indicated by reference numeral 800. Process 800 includes receiving a signal indicative of an activation characteristic of a control element of a remote control (block 802), activating a volume control feature when the activation characteristic is a first or second direction and the television is operating in a viewing mode (block 804), activating a television content selection feature when the activation characteristic is a third or fourth direction and the television is operating in the viewing mode (block 806), and activating a main menu when the activation characteristic is a fifth direction and the television is operating in the viewing mode (808). It should be noted that the first, second, third, fourth and fifth directions are each different in accordance with present embodiments.

What is claimed is:

1. A television remote control system, comprising:
a remote control comprising:
a control element configured for vertical movement, horizontal movement and axial movement; and
a television configured to activate various television features upon receiving a signal from the remote control indicating an activation direction of the control element, wherein the television is configured to activate a volume control feature when the activation direction is a first or second direction and the television is operating in a viewing mode, and wherein the television is configured to activate a television content selection feature when the activation direction is a third or fourth direction and the television is operating in the viewing mode, wherein the first, second, third, and fourth directions are each different.

2. The television remote control system of claim 1, wherein the television is configured to tune a previous channel when the signal indicates movement of the control element in a predefined direction within a threshold after activation of the television content selection feature.

3. The television remote control system of claim 1, wherein the remote control comprises a power button configured to turn the television on when the power button is activated.

4. The television remote control system of claim 1, wherein the television is configured to initiate a mute function when the signal indicates movement of the control element in the third direction within a threshold after activation of the volume control feature.

5. The television remote control system of claim 4, wherein the threshold is defined by a period of time between activation of the volume control feature and deactivation of the volume control feature.

6. The television remote control system of claim 1, wherein the television is configured to close the volume control feature when the signal indicates movement of the control element in the fourth direction within a threshold after activation of the volume control feature.

7. The television remote control system of claim 1, wherein the television is configured to perform a freeze function when the signal indicates movement of the control element in a predefined direction within a threshold after activation of a menu feature by axial movement of the control element.

8. The television remote control system of claim 1, wherein the television is configured to provide graphical displays with graphic features that correspond to related text on the remote control.

9. The television remote control system of claim 1, wherein the television is configured to initiate a select function when the signal indicates movement of the control element in an axial direction.

10. The television remote control system of claim 1, wherein the television is configured to open a menu when the activation direction is a result of axial movement of the control element and the television is operating in the viewing mode.

11. The television remote control system of claim 1, wherein the remote control consists essentially of a power button configured to turn the television on when the power button is activated, and the control element, wherein the control element is configured to initiate commands based on vertical movement, horizontal movement and axial movement.

12. The television remote control system of claim 1, wherein the first and second directions are horizontal, the third and fourth directions are vertical, and wherein the television is configured to activate a main menu when the signal indicates axial movement and the television is operating in the viewing mode.

13. A method, comprising:
receiving a signal indicative of an activation characteristic of a control element of a remote control;
activating a volume control feature when the activation characteristic is a first or second direction and the television is operating in a viewing mode;
activating a television content selection feature when the activation characteristic is a third or fourth direction and the television is operating in the viewing mode; and
activating a main menu when the activation characteristic is a fifth direction and the television is operating in the viewing mode, wherein the first, second, third, fourth and fifth directions are each different.

14. The method of claim 13, wherein the first direction and the second direction are within a horizontal movement range of the control element.

15. The method of claim 13, comprising initiating a mute function when the signal indicates movement of the control element in the third direction within a threshold after activation of the volume control feature.

16. The method of claim 15, wherein the threshold is defined by a period of time between activation of the volume control feature and deactivation of the volume control feature.

17. The method of claim 13, comprising closing the volume control feature when the signal indicates movement of the control element in the fourth direction within a threshold after activation of the volume control feature.

18. The method of claim 13, wherein the third direction and the fourth direction are within a vertical movement range of the control element.

19. The method of claim 13, wherein the fifth direction includes axial movement of the control element.

20. A remote control for a television, the remote control comprising:
a manual control moveable along at least a first axis and a second axis, wherein movement along the first axis is associated with volume and wherein movement along the second axis is associated with volume if the movement along the second axis occurs within a time threshold of the movement along the first axis and wherein the movement along the second axis is associated with television content if the movement along the second axis occurs after the time threshold.
